(19) United States
(12) Patent Application Publication
(10) Pub. No.: US 2016/0135491 A1
(43) Pub. Date: May 19, 2016

(54) KENAF SEED-BASED FLOURS AND PRODUCTS MADE THEREWITH

(71) Applicant: Michael H. Elley, Hermitage, TN (US)

(72) Inventor: Michael H. Elley, Hermitage, TN (US)

(21) Appl. No.: 14/930,734

(22) Filed: Nov. 3, 2015

Related U.S. Application Data
(60) Provisional application No. 62/080,059, filed on Nov. 14, 2014.

(51) Int. Cl. A23L 1/36; A23L 1/10

(52) U.S. Cl. CPC A23L 1/366; A23L 1/1041; A23V 2002/00

(57) ABSTRACT

Flours made from 1) ground/milled whole Kenaf seed, either by itself or in combination with other flours; and 2) flour made from ground/milled DKSM in combination with other types of flour (including flour made from whole Kenaf seed) are disclosed, as are comestible products made with such flours.

### CROSS-REFERENCE TO RELATED APPLICATIONS

This application is based on and claims the priority benefit of U.S. provisional application No. 62/080,059 filed Nov. 14, 2014, the contents of which are incorporated herein by reference.

### FIELD OF THE INVENTION

In general, the invention relates to food products. More particularly, the invention relates to flours made using non-customary sources and, in particular, Kenaf seed.

### BACKGROUND OF THE INVENTION

Of the various plants people have used for food or other purposes, Kenaf is not particularly well known or generally known (i.e., to laypeople) in the Western Hemisphere. However, Kenaf has been used as a cordage crop to produce twine, rope, and sackcloth for over six millennia. Kenaf was first domesticated and used in northern Africa, and India has produced and used Kenaf for the last 200 years. Russia started producing Kenaf in 1902 and introduced the crop to China in 1935. In the United States, Kenaf research and production began during World War II, to supply cordage material for the war effort.

Once it was determined that Kenaf was a suitable crop for U.S. production, research was initiated to maximize U.S. Kenaf yields. As a result, scientists successfully developed high-yielding anthracnose-resistant cultivars; cultural practices; and harvesting machinery that increased fiber yields. Then, in the 1950s and early 1960s, as USDA researchers were evaluating various plant species to fulfill future fiber demands in the U.S., it was determined that Kenaf is an excellent source of cellulose fiber for a large range of paper products (e.g., newsprint, bond paper, and corrugated liner board). Subsequently, more recent research and development work in the 1990s demonstrated the plant's suitability for use in building materials (particle boards of various densities and thicknesses, with desirable fire- and insect-resistance); adsorbents; textiles; livestock feed (leaves and silage); and fibers for use in new and recycled plastics (injected molded and extruded).

Further still, it has been known to press Kenaf seed to obtain its oil for various purposes—primarily for use as a cooking oil but also including use in cosmetics; neutraceuticals; industrial lubricants; and biofuel (biodiesel; jet fuel).

Kenaf has not otherwise been viewed generally as a human food source. Although, the literature has mentioned consuming the “meal,” which is the byproduct remaining from oil extraction—referred to as defatted Kenaf seed meal, or “DKSM”—and which has been suggested for use as a cooking flour, it is not believed that such DKSM has been adopted as a food source on a population-supporting scale.

On another note, in recent years, many people's diets have tended to be high in fat and carbohydrate and lower in protein than is recommended. Furthermore, while wheat-based flour and, to a lesser extent, various other grain-based flours have long been a staple of the American diet, it has become increasingly common for people to suffer from gluten sensitivity/allergies, which makes such gluten-containing flours unsuitable for those segments of the population.

### SUMMARY OF THE INVENTION

The present invention features 1) flour made from ground/milled whole Kenaf seed (referred to as “whole-seed-based Kenaf flour”), either by itself or in combination with one or more other flours; and 2) flour made from ground/milled DKSM (referred to as “DKSM-based Kenaf flour”) in combination with one or more other types of flour (including whole-seed-based Kenaf flour). Collectively, we refer to whole-seed-based flour and DKSM-based flour as “Kenaf seed flour;” and we refer more generally to any flour that contains milled/ground Kenaf seeds—either whole-seed-based flour or DKSM-based flour and either alone or in combination with other flours (whole-seed-based, DKSM-based, or otherwise)—as “Kenaf seed-based flour.” Thus, we have created several novel cooking flours, which provide the nutritional benefits of 1) Kenaf or 2) Kenaf in combination with that of any other flour(s).

Significantly, each of the Kenaf seed flours is gluten-free, which allows those who are gluten-sensitive to consume it, and it is high in protein (24%-34% by weight). In fact, the protein content is high enough for products made using the Kenaf seed flours to contribute meaningfully to a better-balanced diet.

When the whole seeds—in contrast to DKSM—are ground into flour, the flour retains the seed oil (approximately 20% of the total seed weight), which carries with it significant nutritional and health benefits. In particular, Kenaf oil is high in omega polyunsaturated fatty acids (PUFAs), which are known to help in keeping humans healthy, e.g., by contributing to normal growth; functioning as antioxidants; and reducing cholesterol and heart disease. Kenaf seed oil contains a high percentage of linoleic acid (Omega-6), which is a polyunsaturated fatty acid (PUFA). Constituting 45% of the PUFAs present in the Kenaf seed oil, linoleic acid is the dominant PUFA, followed by oleic acid (Omega-9) at 28%. Alpha-linoleic acid (Omega-3) is also present in the Kenaf seed oil at about 2% to 4%, as is palmitic acid (19%) and stearic acid (3%).

A major benefit of making cooking flour from Kenaf seeds (either whole seed or DKSM) is the fact that there are no toxins in these seeds; additionally, the flour is hypo-allergenic, and thus safer for those who may suffer from food allergies. Furthermore, Kenaf seeds are not genetically modified, so consuming flour made using Kenaf seeds will not affect the health of the end user from that standpoint. Further still, when combined with other flours such as wheat flour, rye flour, barley flour, oat flour, etc., Kenaf seed flour can reduce the net percentage of gluten in the combined flour product, thus providing an additional benefit for the consumer who wishes to retain the taste of wheat-based flour, etc., and still limit the amount of gluten consumed.

### EXAMPLARY EMBODIMENTS OF THE INVENTION

### First Example

As a first exemplary embodiment of the invention, whole-seed Kenaf seed flour was prepared by grinding/milling 300 pounds of whole Kenaf seed (Tanung #2). It has been shown that whatever the cultivar of Kenaf seeds used for flour, the taste remains the same. (Milling machines that are able to grind seeds having oil content should be used exclusively in the preparation of Kenaf flour.) This process yields approximately 1.5 times the volume of flour on a per-pound basis of seed.

### Second Example

As a second exemplary embodiment of the invention, an edible product, Kenaf Cookies, was prepared as follows:
Kenaf seed flour (either whole-seed or DKSM-based flour): 1 cup
Oat flour: 2 cups
Flax flour: ½ cup
Baking powder: 1½ tsp
Baking soda: ½ tsp
Cocoa (HERSHEY): ½ cup
Coconut oil (unrefined): ¾ cup OR Butter: 1 Cup
Eggs: 2
Vanilla extract: 2 tsp
Honey: ½ cup
Cinnamon: 2 tsp
Raisins: 2 cups
White chocolate chips: 1½ cups
Sea salt: ½ tsp

Sift Kenaf seed flour and oat flour and mix together (thus obtaining a Kenaf seed-based flour mixture as defined above). Mix salt, baking powder, and baking soda together in small bowl. Cream coconut oil (or butter) and honey together. Add eggs one at a time, mix with mixer. Add vanilla extract, baking powder, baking soda, cinnamon, and cocoa. Add flax flour and mix well. Gradually mix dry ingredients, adding raisins and white chocolate chips as mixing. Cool in refrigerator 1 hour. Let dough warm 10-15 minutes and scoop onto parchment paper. Place in freezer 16 minutes. Remove from freezer and bake in 375 degree preheated oven 12 minutes.

These cookies were then tested among staff for overall palatability, i.e., acceptable taste, texture, etc. This testing showed that minor adjustments were needed with the texture of the flax flour; once corrected, the cookies received total acceptance. Those who were familiar with other “gluten-free” products agreed that the taste and texture of the Kenaf cookies far exceeded anything they had experienced before.

### Third Example

As a third exemplary embodiment of the invention, “Kenaf Dog Treats” were prepared as follows:
Kenaf seed flour (either whole-seed or DKSM-based flour): 1 cup
Flax flour: 1 cup
Purified drinking water: ¾ cup

Mix dry ingredients together. Add water and mix well. Roll ¼ inch and cut with cookie cutters. Place on parchment paper and bake in 350 degree preheated oven 40 minutes. It was found that the majority of all dogs love these treats! It was further discovered that horses also love these treats.

Fourth Example

As a fourth exemplary embodiment of the invention, kenaf-based rice noodles were prepared as follows:
1⅔ (1.66) cup rice flour
⅓ cup kenaf flour (whole-seed and/or DKSM-based flour)
1 cup tapioca
½ teaspoon salt
1 cup water

Add 2 teaspoons kenaf oil and mix into flour. Gradually add ½ to 1 cup of water until consistency of dough (not sticky). Press and cut noodles using tapioca flour to keep the noodles from sticking together. Drop in boiling water and cook for 3 to 4 minutes or until al dente.

### Fifth Example

As a fifth exemplary embodiment of the invention, kenaf-based rice noodles were prepared as follows:
kenaf flour-⅔ cup (whole-seed and/or DKSM-based flour)
rice flour-1⅓ cup
tapioca flour-1 cup
sea salt-½ teaspoon

Gradually add ½ to 1 cup of water until consistency of dough (not sticky). Press and cut noodles using tapioca flour to keep them from sticking together. Drop in boiling water, and cook for 3 to 4 minutes or until al dente.

Sixth Example

As a sixth exemplary embodiment of the invention, kenaf-based wheat noodles were prepared as follows:
kenaf flour-1-cup (whole-seed and/or DKSM-based flour)
wheat flour-1-cup

Mix 1 egg into flour mixture. Gradually add ¼ to ½ cup of water until consistency of dough (not sticky). Press and cut noodles using tapioca flour, to keep the noodles from sticking together. Drop noodles in boiling water and cook for 3 to 4 minutes or until al dente.

### Seventh Example

As a seventh exemplary embodiment of the invention, kenaf-based spaghetti noodles were prepared as follows:
kenaf flour-¼ cup (whole-seed and/or DKSM-based flour)
flax flour-¼ cup
all-purpose flour (wheat)-1½ cups
1 tsp kenaf oil
2 eggs
½ tsp salt

Add 1 teaspoon kenaf oil to 2 beaten eggs and incorporate into flour mixture. Knead dough for 8 minutes. Wrap in plastic wrap and let rest 1 hour. Press and cut noodles using flour to keep them from sticking together. Drop in boiling water. Cook for two minutes or until al dente.

The foregoing disclosure is only intended to be exemplary of the methods and products of the present invention. Departures from and modifications to the disclosed embodiments may occur to those having skill in the art. The scope of the invention is set forth in the following claims.

I claim:

1. Kenaf seed-based flour comprising whole-seed-based Kenaf flour made from whole Kenaf seed that has been milled or ground.

2. Kenaf seed-based flour according to claim 1, comprising a mixture of said whole-seed-based Kenaf flour and DKSM-based Kenaf flour made from defatted Kenaf seed meal that has been milled or ground.

3. Kenaf seed-based flour according to claim 1, comprising a mixture of said whole-seed-based Kenaf flour and one or more additional flours selected from the group consisting of flax flour, wheat flour, rye flour, barley flour, oat flour, or any other flour.

4. Kenaf seed-based flour comprising a mixture of DKSM-based Kenaf flour made from defatted Kenaf seed meal and one or more additional flours selected from the group consisting of flax flour, wheat flour, rye flour, barley flour, oat flour, or any other flour.

5. A comestible food product that has been made using a Kenaf seed-based flour according to claim 1.

6. A comestible food product that has been made using a Kenaf seed-based flour according to claim 2.

7. A comestible food product that has been made using a Kenaf seed-based flour according to claim 3.

8. A comestible food product that has been made using a Kenaf seed-based flour according to claim 4.
